(19) United States
(12) Patent Application Publication
(10) Pub. No.: US 2012/0285600 A1
(43) Pub. Date: Nov. 15, 2012

(54) PNEUMATIC TIRE

(75) Inventor: Daichi NAKAMURA, Hiratsuka-shi (JP)

(73) Assignee: THE YOKOHAMA RUBBER CO., LTD., Tokyo (JP)

(21) Appl. No.: 13/555,552

(22) Filed: Jul. 23, 2012

Related U.S. Application Data
(62) Division of application No. 12/563,707, filed on Sep. 21, 2009.

(30) Foreign Application Priority Data
Sep. 26, 2008 (JP) 2008-248048

(51) Int. Cl. B60C 5/00

(52) U.S. Cl. 152/539

(57) ABSTRACT

A pneumatic tire including: a pair of beads provided to face each other in a tire width direction; a carcass formed across the pair of beads; and an inner liner provided on an inner side of the carcass in a tire radial direction, the inner liner having an elastic modulus that is higher in the tire width direction than in a tire circumferential direction.

### CROSS-REFERENCE TO THE RELATED APPLICATION(S)

This application is a Division of application Ser No. 12/563707, filed Sep. 21, 2009. The present disclosure also relates to the subject matters contained in Japanese Patent Application No. 2008-248048 filed on Sep. 26, 2008 These applications are incorporated herein by reference.

### FIELD

The present invention relates to a pneumatic tire, which is used for vehicles such as cars, trucks, and buses.

### BACKGROUND

Conventionally, a pneumatic tire generally includes a carcass layer formed across a pair of beads in the tire width direction and an inner liner on an inner side in a tire radial direction of the carcass layer.

The inner liner is made of rubber with low gas permeability and has a function of suppressing air leakage from the inside of the tire, however, when deflection in the tire radial direction increases as in the case of low-pressure traveling, the inner liner easily cracks in the tire circumferential direction. Therefore, conventionally, the inner liner is prevented from cracking by increasing the thickness of the inner liner or separately providing rubber for preventing cracks between the inner liner and the carcass layer. An example of such technique is disclosed in JP-A-9-272308.

However, when the thickness of the inner liner is increased or rubber for preventing cracks is separately provided as in the conventional configuration, the manufacturing cost and the weight of the tire increases and the fuel efficiency of a vehicle equipped with the tire would be deteriorated.

### SUMMARY

One of objects of the present invention is to provide a pneumatic tire in which the inner liner can be effectively prevented from cracking without increasing manufacturing cost and weight of the pneumatic tire.

According to an aspect of the invention, there is provided a pneumatic tire including: a pair of beads provided to face each other in a tire width direction; a carcass formed across the pair of beads; and an inner liner provided on an inner side of the carcass in a tire radial direction, the inner liner having an elastic modulus that is higher in the tire width direction than in a tire circumferential direction.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a partial front sectional view of a pneumatic tire showing an embodiment of the present invention.

FIG. 2 is a schematic view of an inner liner in a tire molding process.

FIG. 3 is a view showing test results.

FIG. 4 is a view showing test results.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted.

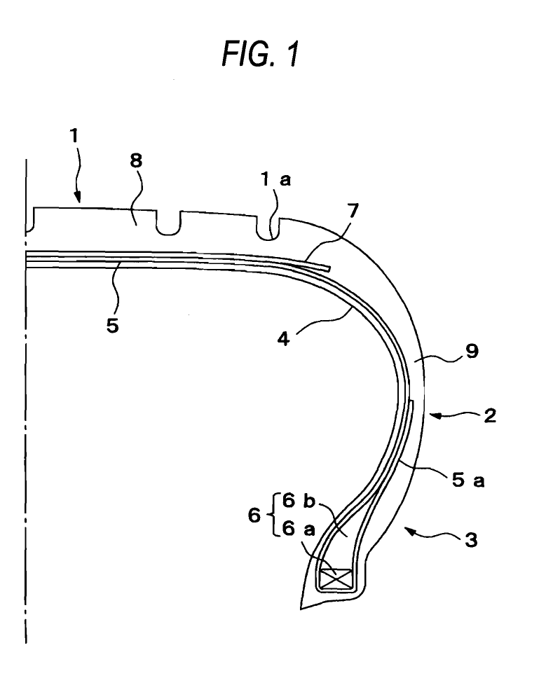

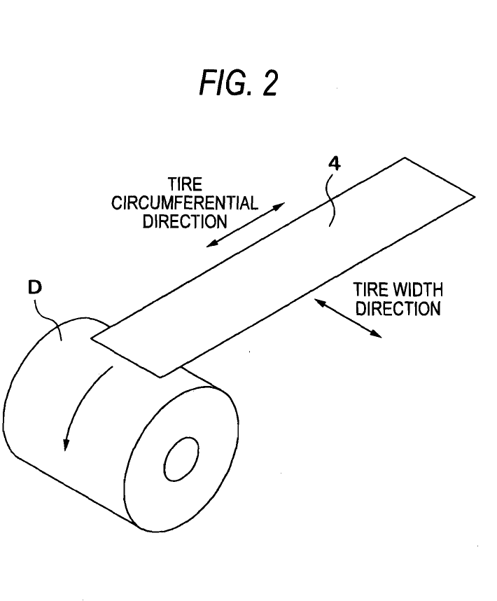

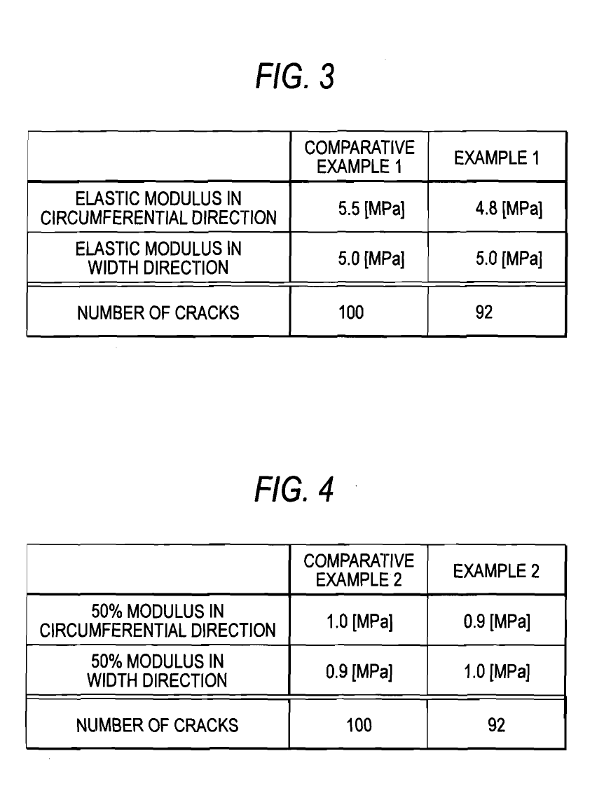

FIG. 1 to FIG. 4 show an embodiment of the present invention, and FIG. 1 is a partial sectional front view of a pneumatic tire, FIG. 2 is a schematic view of an inner liner in a tire molding process, and FIG. 3 and FIG. 4 are views showing test results.

The pneumatic tire shown in the figures includes a tread portion 1 formed on the tire outer peripheral surface side, a pair of side walls 2 formed on both sides in the tire width direction, and a pair of beads 3 formed on both sides in the tire width direction. This pneumatic tire is formed of an inner liner 4 disposed on a tire inner surface side, a carcass member 5 disposed on an outer side of the inner liner 4, a pair of bead members 6 disposed on both sides in the tire width direction, a belt 7 disposed on an outer side of the carcass member 5, a tread member 8 disposed on a tire outer peripheral surface side, and a pair of side wall members 9 disposed on both side surface sides of the tire.

The inner liner 4 is formed of a rubber sheet with low gas permeability, and is disposed on the inner peripheral surface side of the carcass member 5. The inner liner 4 is formed so that an elastic modulus in the tire width direction becomes higher than that in the tire circumferential direction, and as shown in FIG. 2, in a tire forming process, the inner liner is wound around a forming drum D so that its longitudinal direction becomes the tire circumferential direction.

The carcass member 5 is formed of a rubber sheet including a plurality of carcass cords 5a aligned in the tire circumferential direction, and both end sides in the width direction of the carcass member are folded to the sides of the side walls 2 from the inner side toward the outer side in the tire width direction so as to involve the bead members.

The bead member 6 includes a bead core 6a formed by binding wires such as metal wires, and a bead filler 6b formed of rubber having a substantially triangular section, and the bead filler 6b is disposed on the outer peripheral side of the bead core 6a.

The belt 7 is formed by covering a belt cord made of steel or high-strength fiber, etc., with a rubber sheet and is disposed on the outer peripheral surface side of the carcass member 5.

The tread member 8 is made of rubber formed by extrusion molding, and is disposed to cover the center side in the width direction of the carcass member 5 and the outer peripheral surface side of each belt 7, and on the outer peripheral surface of the tread member, grooves 1a of a tread pattern are formed at the time of vulcanization molding.

The side wall members 9 are made of rubber formed by extrusion molding, and are disposed to cover both sides in the tire width direction of the carcass member 5.

In the pneumatic tire configured as described above, an elastic modulus in the tire width direction of the inner liner 4 is higher than that in the tire circumferential direction, so that even when deflection in the tire radial direction increases such as in the case of low-pressure traveling, cracks of the inner liner 4 in the tire circumferential direction are suppressed.

Here, a crack test is conducted for Example 1 of the present invention and Comparative example 1, and the results shown in FIG. 3 are obtained. For Comparative example 1, a tire including an inner liner which has an elastic modulus 10% higher in the tire circumferential direction than in the tire width direction, that is, a tire including an inner liner which has a storage elastic modulus of 5.0 MPa at 20° C. in the tire width direction and a storage elastic modulus of 5.5 MPa at 20° C. in the tire circumferential direction, is used. For Example 1, a tire including an inner liner which has an elastic modulus 4% higher in the tire width direction than in the tire circumferential direction, that is, a tire including an inner liner which has a storage elastic modulus of 5.0 MPa at 20° C. in the tire width direction and a storage elastic modulus of 4.8 MPa at 20° C. in the tire circumferential direction, is used. Here, the storage elastic modulus at 20° C. is measured under conditions of an initial distortion of 10%, an amplitude of 2%, a frequency of 20 Hz, and an atmospheric temperature of 20° C. by using a viscoelastic spectrometer (made by Toyo Seiki Seisaku-Sho, Ltd.). The tires used in this test has a tire size of 225/45R18 and an air pressure of 180 kPa.

In this test, after traveling for 4800 kilometers in a low-pressure traveling test using an indoor drum tester, the number of cracks in the tire circumferential direction occurring on the inner surface of the inner liner is indexed by defining the number of cracks in Comparative example 1 as 100, and Example 1 is evaluated based on the index by defining that the smaller the index, the higher the superiority. As a result of the test, the number of cracks is smaller in Example 1 than in Comparative example 1. In this case, the storage elastic modulus at 20° C. of the inner liner is preferably 3% or more and 13% or less higher in the tire width direction than that in the tire circumferential direction.

Further, a crack test is conducted for Example 2 of the present invention and Comparative example 2, and the results shown in FIG. 4 are obtained. For Comparative example 2, a tire including an inner liner which has an elastic modulus 11% higher in the tire circumferential direction than in the tire width direction, that is, a tire including an inner liner which has a 50% modulus of 1.0 MPa in the tire circumferential direction and a 50% modulus of 0.9 MPa in the tire width direction, is used. For Example 2, a tire including an inner liner which has an elastic modulus 11% higher in the tire width direction than in the tire circumferential direction, that is, a tire including an inner liner which has a 50% modulus of 1.0 MPa in the tire width direction and a 50% modulus of 0.9 MPa in the tire circumferential direction, is used. Here, the 50% modulus is a stress when a rubber sheet is cut into a dumbbell specimen with a thickness of 2 mm (dumbbell No. 3) according to JIS K6251 and is 50% distorted at a room temperature of 23° C.

In this test, as in the case of the aforementioned test, after traveling for 4800 kilometers in a low-pressure traveling test using an indoor drum tester, the number of cracks in the tire circumferential direction on the inner surface of the inner liner is indexed by defining the number of cracks in Comparative example 2 as 100, and Example 2 is evaluated based on the index by defining that the smaller the index, the higher the superiority. As a result of the test, the number of cracks is smaller in Example 2 than in Comparative example 2. In this case, preferably, the 50% modulus in the tire width direction is not less than 0.8 MPa and not more than 1.2 MPa, the 50% modulus in the tire circumferential direction is not less than 0.7 MPa and not more than 1.1 MPa, and the 50% modulus in the tire width direction is 5% or more and 15% or less higher than that in the tire circumferential direction.

As described above, according to the pneumatic tire of the present embodiment, the inner liner 4 is formed so that the elastic modulus in the tire width direction becomes higher than that in the tire circumferential direction, and therefore, even when deflection in the tire radial direction increases such as in the case of low-pressure traveling, cracks in the tire circumferential direction on the inner liner 4 can be suppressed, and the durability can be improved.

In this case, by forming the inner liner 4 so that the storage elastic modulus at 20° C. in the tire width direction becomes 3% or more and 13% or less higher than the storage elastic modulus at 20° C. in the tire circumferential direction, a sufficient crack prevention effect can be obtained, and cracks in the tire width direction due to an excessively high elastic modulus in the tire width direction can be prevented.

Further, by forming the inner liner 4 so that the 50% modulus in the tire width direction becomes not less than 0.8 MPa and not more than 1.2 MPa, the 50% modulus in the tire circumferential direction becomes not less than 0.7 MPa and not more than 1.1 MPa, and the 50% modulus in the tire width direction becomes 5% or more and 15% or less higher than that in the tire circumferential direction, a sufficient crack prevention effect can be obtained, and cracks in the tire width direction due to an excessively high elastic modulus in the tire width direction can be prevented.

According to the present invention, even when deflection in the tire radial direction increases such as in the case of low-pressure traveling, cracks of the inner liner in the tire circumferential direction can be suppressed, so that the durability can be improved.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from the configurations described as the embodiments. Further, the components described in different embodiments may be used appropriately in combination.

1. A pneumatic tire comprising:
a pair of beads provided to face each other in a tire width direction;
a carcass formed across the pair of beads; and
an inner liner provided on an inner side of the carcass in a tire radial direction, the inner liner having an elastic modulus that is higher in the tire width direction than in a tire circumferential direction;
wherein the inner liner has a 50% modulus in the tire width direction being set to be in a range from 0.8 MPa to 1.2 MPa and a 50% modulus in the tire circumferential direction being set to be in a range from 0.7 MPa to 1.1 MPa, and
wherein the 50% modulus in the tire width direction is set to be higher by 5% or more and 15% or less than the 50% modulus in the tire circumferential direction.

2. The pneumatic tire according to claim 1, wherein the inner liner has a storage elastic modulus that is 3% or more and 13% or less higher in the tire width direction at 20° C. than in the tire circumferential direction at 20° C.

3. (canceled)
